(19) United States
(12) Patent Application Publication
(10) Pub. No.: US 2026/0351487 A1
(43) Pub. Date: Nov. 5, 2026

(54) SOLID ELECTROLYTIC CAPACITOR AND MANUFACTURING METHOD THEREOF

(71) Applicant: NIPPON CHEMI-CON CORPORATION, Tokyo (JP)

(72) Inventors: Megumi MIGITA, Fukushima (JP); Kenta SATO, Kanagawa (JP); Ippei NAKAMURA, Fukushima (JP); Mizuki NAKAMURA, Fukushima (JP)

(21) Appl. No.: 19/142,885

(22) PCT Filed: Dec. 26, 2023
(86) PCT No.: PCT/JP2023/046798

§ 371 Date: Jun. 18, 2026

(30) Foreign Application Priority Data
Dec. 26, 2022 (JP) 2022-208511

(51) Int. Cl. H01G 9/15; H01G 9/00; H01G 9/025

(52) U.S. Cl. CPC H01G 9/15; H01G 9/0036; H01G 9/025

(57) ABSTRACT

A solid electrolytic capacitor in which the change in ESR due to the thermal shock is suppressed, and a manufacturing method thereof are provided. The solid electrolytic capacitor includes an anode body, a cathode body, and an electrolyte layer. The anode body contains valve metal, and dielectric film is formed on a surface thereof. The cathode body faces the anode body. The electrolyte layer intervenes between the anode body and the cathode body, and contains electrolytic solution and conductive polymers. The electrolytic solution contains the aliphatic dicarboxylic acid with the acid dissociation constant pKa=4.52 or more, and the conductive polymer has D50 in the particle size distribution of 50 nm or less.

### FIELD OF INVENTION

The present disclosure relates to a solid electrolytic capacitor in which an electrolyte layer includes electrolytic solution and conductive polymers, and a manufacturing method thereof.

### BACKGROUND

Electrolytic capacitors include valve metal, such as tantalum or aluminum, as anode foil and cathode foil. A surface of the anode foil is enlarged by making the valve metal into a sintered body or a shape such as etching foil, and the enlarged surface has a dielectric film layer thereon. The specific surface area of this electrolytic capacitor can be enlarged by enlarging the surface of the anode foil, achieving large capacitance and satisfying higher power demand.

The electrolytic solution intervenes between the anode foil and the cathode foil. The electrolytic solution closely contacts the uneven surface of the anode foil and acts as a true cathode. An area of the dielectric film of the anode foil that contacts the electrolytic solution increases. Therefore, the capacitance of the electrolytic capacitor can be further increased, which is suitable for high capacity along the recent higher power demand. Evaporation and volatilization where the electrolytic solution is released outside the electrolytic capacitor over time may occur. Therefore, the capacitance of the electrolytic capacitor decreases over time toward dry-up and the tangent (tan d) of the loss angle increases over time, and finally, the electrolytic capacitor ends its lifetime.

Accordingly, solid electrolytic capacitors using solid electrolytes are getting attention among the electrolytic capacitors. Manganese dioxide and 7,7,8,8-tetracyanoquinodimethane (TCNQ) complexes are known as a solid electrolyte. In recent years, solid electrolytic capacitors using the conductive polymer derived from monomers having π-conjugated double bonds, such as poly(3,4-ethlenedioxythiophene) (PEDOT) with slow reaction speed and excellent adhesion to the dielectric film, are rapidly becoming popular. In the conductive polymer, acid compounds such as polyanionic components are used as a dopant, and the conductive polymer has a partial structure acting as the dopant in monomer molecules, exhibiting high conductivity. Therefore, the solid electrolytic capacitor is advantageous in that the equivalent series resistance (ESR) becomes low.

However, the electrolytic capacitors with solid electrolytes are less effective in repairing defects in the dielectric film than the electrolytic capacitors with electrolytic solution. Therefore, a so-called hybrid-type electrolytic capacitor, which is impregnated with the electrolytic solution while the conductive polymer is intervened between the anode foil and the cathode foil, is getting attention.

### PRIOR ART DOCUMENT

### Patent Document

Patent Document 1: JP2017-38010A

### SUMMARY OF INVENTION

### Problems to be Solved by Invention

For example, in the field of in-vehicle application and power distribution in cold areas, the electrolytic capacitor may be drastically heated from low temperature such as −55 °C to high temperature such as 155 °C, or conversely, may be drastically cooled from high temperature such as 155 °C to low temperature such as-55 °C. This drastic change in temperature is called thermal shock.

The electrolytic capacitor that has repeatedly undergone the thermal shock are prone to the deterioration of the ESR due to the deterioration by the thermal shock. If the ESR becomes larger, various effect occurs, such as the electrolytic capacitor easily heating up, the lifetime of the electrolytic capacitor becoming short, and the generation of large ripple voltage.

The present disclosure has been proposed to address the above problems, and an objective is to provide a solid electrolytic capacitor in which the change in ESR due to the thermal shock is suppressed, and the manufacturing method thereof.

### Means to Solve the Problem

To address the above problems, a solid electrolytic capacitor of the present embodiment includes: anode body containing valve metal and has dielectric film formed on a surface thereof; a cathode body facing the anode body; and an electrolyte layer intervening between the anode body and the cathode body and containing electrolytic solution and a conductive polymer, in which the electrolytic solution contains aliphatic dicarboxylic acid with an acid dissociation constant pKa=4.52 or more, and D50 in a particle size distribution of the conductive polymer is 50 nm or less.

When the acid dissociation constant pKa is large, the withstand voltage of the solid electrolytic capacitor can be made larger, which is suitable for in-vehicle application and power distribution. However, if the electrolytic solution contains the aliphatic dicarboxylic acid with the acid dissociation constant pKa=4.52 or more, the change in ESR when the solid electrolytic capacitor repeatedly undergoes the thermal shock becomes particularly large. Meanwhile, if the electrolytic solution contains the aliphatic dicarboxylic acid with the acid dissociation constant pKa=4.52 or more and the electrolyte layer contains the conductive polymer with D50 in the particle size distribution of 50 nm or less, this change in ESR is suppressed.

The electrolyte layer may contain polyhydric alcohol. That is, in this solid electrolytic capacitor, the electrolytic solution contains the aliphatic dicarboxylic acid with the acid dissociation constant pKa=4.52 or more, the electrolyte layer contains the conductive polymer with D50 in the particle size distribution of 50 nm or less and contains polyhydric alcohol. The change in ESR of this solid electrolytic capacitor is suppressed to the same level as that of a capacitor in which electrolytic solution contains aliphatic dicarboxylic acid with the acid dissociation constant pKa=4.51 or less.

The electrolyte layer may be formed using conductive polymer solution containing the conductive polymer and the polyhydric alcohol.

The polyhydric alcohol may be contained in an amount of 8 wt % to 50 wt % relative to a total amount of the conductive polymer solution. By this, the change in ESR of this solid electrolytic capacitor is suppressed to the same level as that of a capacitor in which electrolytic solution contains aliphatic dicarboxylic acid with the acid dissociation constant pKa=4.51 or less. Furthermore, the polyhydric alcohol may be contained in an amount of 8 wt % to 30 wt % relative to a total amount of the conductive polymer solution. When the amount of the polyhydric alcohol is restricted in this range, the change in ESR of this solid electrolytic capacitor is suppressed better than that of a capacitor in which electrolytic solution contains aliphatic dicarboxylic acid with the acid dissociation constant pKa=4.51 or less.

The polyhydric alcohol may be one type or a mixture of two or more types selected from a group of polyethylene glycol, xylitol, and sorbitol. When the polyhydric alcohol is contained in the electrolyte layer, the change in ESR of this solid electrolytic capacitor is suppressed to the same level as that of a capacitor in which electrolytic solution contains aliphatic dicarboxylic acid with the acid dissociation constant pKa=4.51 or less.

The aliphatic dicarboxylic acid may be one type or a mixture of two or more types selected from a group of azelaic acid, suberic acid, and sebacic acid.

The electrolytic solution may further contain aliphatic dicarboxylic acid with the acid dissociation constant pKa=4.51 or less. When the aliphatic dicarboxylic acid with the acid dissociation constant pKa=4.52 or more and the aliphatic dicarboxylic acid with the acid dissociation constant pKa=4.51 or less are mixed, and the electrolyte layer contains the conductive polymer with D50 in the particle size distribution of 50 nm or less, the change in ESR when the solid electrolytic capacitor had repeatedly undergone the thermal shock is further suppressed.

Furthermore, to address the above problems, a manufacturing method of a solid electrolytic capacitor of the present embodiment includes: a conductive polymer attachment process of attaching and drying conductive polymer solution to an anode body which has dielectric film formed on a surface thereof or a capacitor element in which said anode body and a cathode body are facing each other; and an electrolytic solution impregnation process of impregnating the capacitor element with electrolytic solution after the conductive polymer attachment process, in which the electrolytic solution contains aliphatic dicarboxylic acid with an acid dissociation constant pKa=4.52 or more, and D50 in a particle size distribution of the conductive polymer is 50 nm or less.

### Effect of Invention

According to the present disclosure, the change in ESR of the solid electrolytic capacitor is suppressed even when the solid electrolytic capacitor had repeatedly undergone the thermal shock.

### BRIEF DESCRIPTION OF DRAWINGS

FIG. 1 is a graph indicating the change in ESR of the solid electrolytic capacitor containing the conductive polymer with D50 the particle size distribution of 450 nm.

FIG. 2 is a graph indicating the relationship between the change in ESR of the comparative example 1, and the examples 1 and 2.

FIG. 3 is a graph indicating the relationship between the change in ESR of the comparative example 3, and the examples 3 to 5.

FIG. 4 is a graph showing the relationship between the types of polyhydric alcohol and the change in ESR.

FIG. 5 is a graph showing the relationship between the addition amount of polyhydric alcohol and the change in ESR.

FIG. 6 is a graph indicating the relationship between the change in ESR of the example 2, the reference examples 2, and the examples 15 to 17.

FIG. 7 is a graph indicating the relationship between the change in ESR of the example 2, the reference example 3, and the examples 18 to 20.

### EMBODIMENTS

Hereinafter, the solid electrolytic capacitor according to embodiments of the present disclosure will be described. Note that the present disclosure is not limited to the following embodiments.

### (Solid Electrolytic Capacitor)

A solid electrolytic capacitor is a passive element that exhibits the capacitance by dielectric polarization of dielectric film and stores and discharges electric charge. The solid electrolytic capacitor includes a capacitor element. The capacitor element includes an anode body, a cathode body, an electrolyte layer, and a separator. Dielectric film is formed on a surface of the anode foil. The anode body and the cathode body are arranged to face each other via the dielectric film. The electrolyte layer intervenes between the dielectric film of the anode body, and the cathode body. The electrolyte layer adheres to the dielectric film of the anode body and acts as a true cathode. Furthermore, the electrolyte layer extends between the dielectric film and the cathode body, forming a conductive path.

This solid electrolytic capacitor is a so-called hybrid-type which includes electrolytic solution and conductive polymers. The electrolyte layer contains at least the electrolytic solution and the conductive polymer. The separator separates the anode body and the cathode body to prevent short-circuit, and also holds the electrolyte layer. If the electrolyte layer can keep its shape on its own and can separate the anode body and the cathode body by the conductive polymer, the separator can be omitted from the solid electrolytic capacitor.

The anode body and the cathode body are laminated alternately via the electrolyte layer. In the laminated-type, other than a planar-type in which an exterior is omitted, for example, the capacitor element is sealed by covering the capacitor element by laminate film or by molding, dip coating, or printing resin such as heat-resistant resin and insulation resin. Otherwise, the anode body and the cathode body are laminated alternately and wound via the electrolyte layer. In this wound-type, for example, the capacitor element is inserted into a cylindrical outer casing with a bottom. An opening of the outer casing is sealed by a crimping process using a sealing body.

After the capacitor element is sealed, aging is performed by applying direct current on the solid electrolytic capacitor under high temperature to repair the oxide film which was damaged during the production of the solid electrolytic capacitor, such as winding. By this, the complete product of the solid electrolytic capacitor is formed.

### (Anode Body)

The anode body is a foil body formed of valve metal. In the wound-type electrolytic capacitor, the anode body is a long strip of elongated valve metal, and in the laminated-type electrolytic capacitor, the anode body is a sintered body formed by molding and sintering a flat plate or powder into a planar shape. The valve metal is aluminum, tantalum, niobium, niobium oxide, titanium, hafnium, zirconium, zinc, tungsten, bismuth, and antimony, etc. The purity of the anode body is desirably 99.9% or more, and impurities such as silicon, iron, copper, magnesium, and zinc may be included.

An enlarged surface layer is formed on one or both surfaces of the anode body. The enlarged surface layer is a surface layer which is processed to enlarge the surface area larger than the projected area, and is an etching layer in which etching is performed on the foil body, a sintered layer in which powder of valve metal is attached and sintered, or a vapor-deposited layer in which particles of valve metal are vapor-deposited on the foil body. That is, the enlarged surface layer has a porous structure and is formed by tunnel-shaped pits, spongy pits, or voids between dense powder bodies or particles.

The tunnel-shaped etching pits are holes dug in the thickness direction of the foil and may penetrate the foil body. Typically, the tunnel-shaped etching pits are formed by applying DC current on the foil body in aqueous acidic solution in which halogen ions are present, such as hydrochloric acid. Furthermore, the tunnel-shaped etching pits are enlarged by applying DC current on the foil body in aqueous acidic solution such as nitric acid. The spongy pits make the enlarged surface layer a spongy layer with a series of fine spatial voids. The spongy etching pits are formed by applying AC current on the foil body in aqueous acidic solution in which halogen ions are present, such as hydrochloric acid.

The sintered layer is formed by attaching and sintering powder of valve metal same as or different from the foil body to the foil body. The powder is obtained by atomizing, melt-spinning, rotating disk, and milling, rotating electrode, etc. The powder is made into paste by binders and solvents, and the paste is applied and dried on the foil body. Then, the paste is heated in vacuum or under reduction atmosphere for sintering. The atomizing may be either of water atomizing, gas atomizing, or water-gas atomizing. For example, the vapor-deposited layer is produced by resistance heating vapor-deposition or electron beam heating vapor-deposition. The vapor-deposited layer is formed by heating and evaporating valve metal same as or different from that of the foil body using resistive heat and electron beam energy, and depositing vapor of the particles of valve metal on the surface of the foil body.

The dielectric film is formed on the surface layer of the anode body along unevenness of the enlarged surface layer. Typically, the dielectric film is oxide film which is the anodically oxidized surface layer of the anode body. When the anode body is aluminum foil, the dielectric film is aluminum oxide layer obtained by oxidizing the surface layer of the anode body along the unevenness of the enlarged surface layer. The dielectric film is formed by chemical conversion treatment. In the chemical conversion treatment, voltage is applied on the anode body in chemical conversion solution to achieve the desired withstand voltage. The chemical conversion solution is solution without halogen ions, and for example is phosphoric acid-based chemical conversion solution such as ammonium dihydrogen phosphate, boric acid-based chemical conversion solution such as ammonium borate, and adipic acid-based chemical conversion solution such as ammonium adipate, etc.

### (Cathode Body)

The cathode body is a stretched foil body formed of valve metal. The purity of the cathode foil is desirably 99% or more, and impurities such as silicon, iron, copper, magnesium, and zinc may be included. The foil body is plane foil with a flat surface or an enlarged surface layer is formed on a surface of the foil body by surface enlargement. Oxide film may be formed on the enlarged surface layer naturally or intentionally. Intentionally, thin oxide film of about 1 to 10 Vfs may be formed by chemical conversion treatment. The natural oxide film is formed when oxygen in the air reacts with the cathode foil.

When the solid electrolytic capacitor is the laminate-type, it is preferable that the cathode body is a laminate of a metal layer and a carbon layer. The carbon layer of the cathode body is arranged toward the anode body. The carbon layer is formed by applying paste of carbon on the electrolyte layer that has been formed on the anode body, and heating and curing the paste. The metal layer may be a silver layer, and is formed by applying paste of said metal on the carbon layer and curing the paste by heating.

Furthermore, the cathode body may further include a conductive layer laminated thereon. The conductive layer contains conductive material and is a layer that is more conductive than the oxide film. This conductive layer is laminated on one surface or both surfaces of the cathode foil and is located at the outermost surface of the cathode body. For example, the conductive material may be titanium, zirconium, tantalum, niobium, and nitrides or carbides thereof, aluminum carbide, carbon material, and composite material or mixture thereof. A plurality of these conductive layers may be laminated, or each layer may be different types of layers. The conductive layer and the cathode body may be a pressure-welded structure. After the conductive layer is laminated, pressing is performed. In the pressure-welded structure, the conductive layer is pressed into the pores of the enlarged surface layer or is deformed along the unevenness of the enlarged surface layer. The pressure-welded structure improves the adhesion and fixability between the conductive layer and the cathode body, and the ESR of the solid electrolytic capacitor is reduced.

### (Electrolyte Layer)

The electrolytic solution of the electrolyte layer contains aliphatic dicarboxylic acid with the acid dissociation constant pKa=4.52 or more as anionic component. When the acid dissociation constant pKa is large, the withstand voltage of the solid electrolytic capacitor can be made larger, which is suitable for in-vehicle application and power distribution. In the aliphatic dicarboxylic acid, two hydrogen of chain hydrocarbon is substituted by hydroxy groups. For example, the aliphatic dicarboxylic acid with the acid dissociation constant pKa=4.52 or more may be azelaic acid, suberic acid, and sebacic acid. One type or a mixture of two or more types selected from a group of azelaic acid, suberic acid, and sebacic acid may be contained in the electrolytic solution of the electrolyte layer. Note that the acid dissociation constant pKa is a value measured in water at 25 °C.

However, when the aliphatic dicarboxylic acid with the acid dissociation constant pKa=4.52 or more is contained, particles with D50 in the particle size distribution of 50 nm or less is contained as the conductive polymer of the electrolyte layer. D50 in the particle size distribution is a median diameter in the volume particle size distribution obtained by the particle size distribution measurement using dynamic light scattering, and hereinafter, the median diameter is referred to as D50 in the particle size distribution. The particle size distribution of the conductive polymer is measured when the conductive polymer is dispersed.

Here, when the aliphatic dicarboxylic acid contained in the electrolyte layer has the acid dissociation constant pKa 4.51 or less, the change in ESR is small even when the solid electrolytic capacitor repeatedly undergoes the thermal shock. In contrast, when the acid dissociation constant of the aliphatic dicarboxylic acid is pKa=4.52 or more, the ESR becomes significantly worse. However, only in the case the electrolyte layer contains the aliphatic dicarboxylic acid with the acid dissociation constant pKa=4.52 or more, and the aliphatic dicarboxylic acid with the acid dissociation constant pKa=4.52 or more and the conductive polymer with the median diameter of 50 nm or less are used together. Then, the deterioration of the conductive polymer due to the thermal shock caused by the rapid change in temperature is suppressed, and the change in ESR is suppressed.

Although it is only assumption and the mechanism is not limited thereto, it is assumed that the change in ESR is suppressed for the following reason. Firstly, the aliphatic dicarboxylic acid with large pKa easily precipitates at low temperature because its linear alkyl chain is long. When the precipitated aliphatic dicarboxylic acid enters between the conductive polymer and the anode body and between the conductive polymer and the cathode body, the interfacial resistance between the conductive polymer and the anode body and between the conductive polymer and the cathode body is increased. Therefore, when the aliphatic dicarboxylic acid with large pKa is used, the deterioration of the ESR due to the thermal shock becomes large.

Meanwhile, the conductive polymer with D50 in the particle size distribution of 50 nm or less densely attached to the anode body and the cathode body. Therefore, even if the aliphatic dicarboxylic acid with the acid dissociation constant pKa=4.52 or more precipitates at low temperature, there is no room for the precipitated aliphatic dicarboxylic acid to enter between the conductive polymer and the anode body and between the conductive polymer and the cathode body in the first place. Therefore, even if the aliphatic dicarboxylic acid precipitates, it does not lead to the increase in the interfacial resistance between the conductive polymer and the anode body and between the conductive polymer and the cathode body.

Also, since the conductive polymer densely attaches to the anode body and the cathode body, many conductive paths have already been formed between the electrolyte layer and the anode body and between the electrolyte layer and the cathode body. Therefore, even if the aliphatic dicarboxylic acid precipitates and there is the aliphatic dicarboxylic acid that has entered into and is present between the conductive polymer and the anode body and between the conductive polymer and the cathode body, the effect of the increase in the interfacial resistance caused by this aliphatic dicarboxylic acid is little considering the presence of a number of conductive paths.

Therefore, only in the case the aliphatic dicarboxylic acid with the acid dissociation constant pKa=4.52 or more is contained, when the aliphatic dicarboxylic acid with the acid dissociation constant pKa=4.52 or more and the conductive polymer with D50 in the particle size distribution of 50 nm or less are contained together in the electrolyte layer, it is assumed that the change in ESR of the solid electrolytic capacitor is suppressed.

Furthermore, when the aliphatic dicarboxylic acid with the acid dissociation constant pKa=4.52 or more and the aliphatic dicarboxylic acid with the acid dissociation constant pKa=4.51 or less is mixed, in addition to the conductive polymer with the median diameter of 50 nm or less, the deterioration of the conductive polymer due to the thermal shock caused by rapid change in temperature is suppressed compared with the solid capacitor containing the aliphatic electrolytic dicarboxylic acid with the acid dissociation constant pKa=4.51 or less as the aliphatic dicarboxylic acid in the electrolyte layer, and the change in ESR is suppressed.

Therefore, it is preferable that the electrolytic solution contains the aliphatic dicarboxylic acid with the acid dissociation constant pKa=4.51 or less as further anionic component. For example, the aliphatic dicarboxylic acid with the acid dissociation constant pKa=4.51 or less may be succinic acid, glutaric acid, and pimelic acid. One type or a mixture of two or more types selected from a group of succinic acid, glutaric acid, and pimelic acid may be contained in the electrolytic solution of the electrolyte layer.

The electrolyte layer may further contain polyhydric alcohol. The polyhydric alcohol may be polyethylene glycol, xylitol, sorbitol, 1-hexanol, ethylene glycol, diethylene glycol, triethylene glycol, polyoxyethylene glycol, glycerin, polyglycerin, polyoxyethylene glycerin, erythritol, mannitol, dipentaerythritol, pentaerythritol, or combination of two or more.

When the aliphatic dicarboxylic acid with the acid dissociation constant pKa=4.52 or more, the conductive polymer with the median diameter of 50 nm or less, and the polyhydric alcohol are used together in the electrolyte layer, the change in ESR after the solid electrolytic capacitor has repeatedly undergone the thermal shock is suppressed to the same level as the solid electrolytic capacitor having the aliphatic dicarboxylic acid with the acid dissociation constant pKa=4.51 or less.

Among the polyhydric alcohol, polyethylene glycol, xylitol, sorbitol, or combination of two or more, with the average molecular weight of 300, is preferable. When these polyhydric alcohol is contained in the electrolyte layer, only the case the aliphatic dicarboxylic acid with the acid dissociation constant pKa=4.52 or more, the conductive polymer with the median diameter of 50 nm or less are contained in the electrolyte layer, the change in ESR is suppressed low than the solid electrolytic capacitor including the aliphatic dicarboxylic acid with the acid dissociation constant pKa=4.51 or less, and the ESR close to before the thermal shock can be maintained.

### (Electrolytic Solution)

The electrolytic solution may include other known components without limitation. The electrolytic solution may contain other types of anion components, in addition to aliphatic dicarboxylic acid with the acid dissociation constant pKa=4.52 or more. Organic acid that is the other types of the anionic components may be other carboxylic acid, phenols, and sulfonic acid. Inorganic acid that is the other types of the anionic components may be boric acid, phosphoric acid, phosphorus acid, hypophosphorous acid, carbonic acid, and silicic acid, etc. The composite compound of organic acid and inorganic acid that is the other types of the anion components may be borodisalicylic acid, borodioxalic acid, borodiglycolic acid, borodimalonic acid, borodisuccinic acid, borodiadipic acid, borodiazelaic acid, borodibenzoic acid, borodimaleic acid, borodilactic acid, borodimalic acid, boroditartric acid, borodicitric acid, borodiphthalic acid, borodi(2-hydroxy) isobutyric acid, borodiresorcinic acid, borodimethylsalicylic acid, borodinaftoeic acid, borodimandelic acid, and borodi(3-hydroxy) propionic acid, etc.

The electrolytic solution may contain known cationic components, in addition to the anion components. A solvent of the electrolytic solution may be a protic organic polar solvent or an aprotic organic polar solvent, and may be used in single or in combination of two or more. The cationic component may be ammonium, quaternary ammonium, quaternarized aminidium, amine, sodium, and potassium, etc. The quaternary ammonium may be tetramethylammonium, triethylmethylammonium, and tetraethylammonium, etc. The quaternary amidinium may be ethyldimethylimidazolinium and tetramethylimidazolinium, etc. The amine may be primary amines, secondary amines, and tertiary amines. The primary amine may be methylamine, ethylamine, propylamine, and the like, the secondary amines may be dimethylamine, diethylamine, ethylmethylamine and dibutylamine, and the like, and the tertiary amines may be trimethylamine, triethylamine, tributylamine, ethyldimethylamine, ethyldiisopropylamine, and the like.

The protic organic solvent that is the solvent may be monohydric alcohol, polyhydric alcohol, and oxyalcohol compounds, etc. The monohydric alcohol may be ethanol, propanol, butanol, pentanol, hexanol, cyclobutanol, cyclopentanol, cyclohexanol, and benzyl alcohol, etc. The polyhydric alcohol and the oxyalcohol compound may be ethylene glycol, diethylene glycol, propylene glycol, glycerin, methyl cellosolve, ethyl cellosolve, methoxypropylene glycol, dimethoxypropanol, polyglycerin, and alkylene oxide adduct of the polyhydric alcohol such as polyethylene glycol, polyoxyethylene glycerin, and polypropyrene glycol, etc.

The aprotic organic polar solvent that is the solvent may be sulfones, amides, lactones, cyclic amides, nitriles, and sulfoxides, etc. The sulfone may be dimethyl sulfone, ethylmethyl sulfone, diethyl sulfone, sulfolane, 3-methyl sulfolane, and 2,4-dimethyl sulfolane, etc. The amide may be N-methylformamide, N,N-dimethylformamide, N-ethylformamide, N,N-diethylformamide, N-methylacetamide, N,N-dimethylacetamide, N-ethylacetamide, and N,N-diethylacetamide, etc. The lactone and the cyclic amide may be y-butyrolactone, γ-valerolactone, δ-valerolactone, N-methyl-2-pyrrolidone, ethylene carbonate, propylene carbonate, butylene carbonate, and isobutylene carbonate, etc. The nitrile may be acetonitrile, 3-methoxypropionitrile, and glutaronitrile, etc. The sulfoxide may be dimethyl sulfoxide, etc.

The capacitor element is immersed in the electrolytic solution to impregnate the electrolytic solution in the voids of the capacitor element. To impregnate the electrolytic solution in finer voids, depressurization process or pressurization process may be performed to impregnation, if necessary. The impregnation process may be repeated multiple times. For example, the interior of the capacitor element may be depressurized, and the electrolytic solution may be injected inside the capacitor element while pressurizing the electrolytic solution.

### (Conductive Polymer)

The conductive polymer contained in the electrolyte layer is a self-doped conjugated polymer doped by dopant molecules in the molecules or a doped conjugated polymer doped by external dopant molecules. The conjugated polymer is obtained by chemical oxidative polymerization or electrolytic oxidative polymerization of monomers with a π-conjugated double bond or derivatives thereof. The conductive polymer exhibits high conductivity the doping reaction to the conjugated polymer. That is, the conductivity is exhibited by adding a small amount of the dopant, such as an acceptor that easily accepts electrons or a donor that easily donates electrons to the conjugated polymer.

Known polymers may be used for the conjugated polymer without limitation. For example, the conjugated polymer may be polypyrrole, polythiophene, and polyaniline, etc. These conjugated polymers may be used in single or in combination of two or more, and may further be a copolymer of two or more types of monomers.

Among the above-described conjugated polymers, conjugated polymers formed by polymerizing thiophene or derivatives thereof is preferable, and conjugated polymers in which 3,4-ethylenedioxythiophene (that is, 2,3-dihydrothieno[3,4-b][1,4]dioxin), 3-alkylthiophene, 3-alkoxythiophene, 3-alkyl-4-alkoxythiophene, 3,4-alkylthiophene, 3,4-alkoxythiophene, or derivatives thereof are polymerized are preferable. The thiophene derivatives may preferably be compounds selected from thiophene with substituents at 3-position and 4-position, and the 3-position and 4-position substituents of the thiophene ring may form a ring together with the 3-position and 4-position carbon. It is preferable that the carbon number of an alkyl group and an alkoxy group is 1 to 16.

In particular, a polymer of 3,4-ethylenedioxythiophene which is called EDOT, that is, poly(3,4-ethylenedioxythiophene) which is called PEDOT is particularly preferable. Furthermore, an alkylated ethylenedioxythiophene in which an alkyl group is added to 3,4-ethylenedioxythiophene may be used, and for example, a methylated ethylenedioxythiophene (that is, 2-methyl-2,3-dihydro-thieno[3,4-b][1,4]dioxin), ethylated ethylenedioxythiophene (that is, 2-ethyl-2,3-dihydro-thieno[3,4-b][1,4]dioxin), and the like may be used.

As the dopant, known dopants may be used without limitation. The dopant may be used in single or in combination of two or more. Also, the dopant may be polymers or monomers. For example, the dopant may be inorganic acid such as polyanions, boric acid, nitric acid, and phosphoric acid, and organic acid such as acetic acid, oxalic acid, citric acid, tartaric acid, squaric acid, logisonic acid, croconic acid, salicylic acid, p-toluenesulfonic acid, 1,2-dihydroxy-3, 5-benzenedisulfonic acid, methanesulfonic acid, trifluoromethanesulfonic acid, borodisalicylic acid, bisoxalate borate acid, sulfonylimide acid, dodecylbenzenesulfonic acid, propylnaphthalenesulfonic acid, and butylnaphthalenesulfonic acid.

For example, the polyanion may be polymers consisting of only component units with anion groups or polymers consisting of component units with anion groups and component units without anion groups, and may be substituted or unsubstituted polyalkylene, substituted or unsubstituted polyalkenylene, substituted or unsubstituted polyimide, substituted or unsubstituted polyamide, and substituted or unsubstituted polyester. In particular, the polyanion may be polyvinyl sulfonic acid, polystyrene sulfonic acid, polyaryl sulfonic acid, polyacrylic sulfonic acid, polymethacrylic sulfonic acid, poly(2-acrylamide-2-methylpropane sulfonic acid), polyisoprene sulfonic acid, polyacrylic acid, polymethacrylic acid, and polymaleic acid, etc.

Here, for example, the conductive polymer is filled in the electrolyte layer by impregnating the capacitor element with conductive polymer solution. The conductive polymer solution may be applied or discharged on the dielectric film of the anode body. The conductive polymer solution is liquid in which particles or powder of the conductive polymer is dispersed. To facilitate the impregnation of the conductive polymer to the capacitor element, depressurization process or pressurization process may be performed as necessary to facilitate the impregnation to the capacitor element. The impregnation process may be repeated multiple times. After the conductive polymer solution is impregnated to the capacitor element, the dispersion medium is removed by drying process.

The conductive polymer with the median diameter of 50 nm or less can be obtained oxidative polymerization. The following is one example method to prepare the conductive polymer with a small median diameter. Among the conductive polymers, PEDOT doped with polystyrene sulfonic acid (PEDOT/PSS) is generally produced by emulsion polymerization. In the emulsion polymerization, PEDOT/PSS with a small particle size can be obtained by making micelles of EDOT smaller using a homogenizer. Furthermore, the polymerized PEDOT/PSS is pulverized using a high-pressure ultrasonic homogenizer to reduce the particle size of PEDOT/PSS. The homogenizer may be a high-pressure type, an ultrasonic type, or a combination of both.

For example, in the chemical oxidative polymerization, solution containing monomers that are monomer units of the conductive polymer and an oxidizing agent are mixed and polymerized. For example, water is used as the solvent. The oxidizing agent may be any known compounds that release dopants, may be trivalent iron salt such as iron (III) p-toluene sulfonate, iron (III) naphthalene sulfonate, and iron (III) anthraquinone sulfonate, or peroxodisulfate salt such as peroxiodisulfuric acid, ammonium peroxodisulfate, and sodium peroxodisulfate, and may be used in single or in combination of two or more. Although there is no strict limitation for the polymerization temperature, the temperature is generally in the range of 10 to 200 degrees. The polymerization time is generally in the range of 10 minutes to 30 hours.

After the polymerization reaction is completed, residual monomers and impurities may be removed by purification such as ultrafiltration, cation exchange, and anion exchange. The solvent of the conductive polymer solution be any solvent if the conductive polymer disperses thereto, and water, or the mixture of water and organic solvents is preferable. The organic solvent of the conductive polymer dispersion may be polar solvents, alcohol, esters, hydrocarbon, carbonate compounds, ether compounds, linear ether, heterocyclic compounds, and nitrile compounds, etc.

The polar solvent may be N-methyl-2-N,N-dimethylformamide, N,N-pyrrolidone, dimethylacetoamide, and dimethylsulfoxide. The alcohol may be methanol, ethanol, propanol, and butanol, etc. The ester may be ethyl acetate, propyl acetate, and butyl acetate, etc. The hydrocarbon may be hexane, heptane, benzene, toluene, and xylene, etc. The carbonate compound may be ethylene carbonate and propylene carbonate, etc. The ether compound may be dioxane, diethylether, etc. The chain ether may be ethylene glycol alkyl ether, propylene glycol alkyl ether, polyethylene glycol dialkyl ether, and polypropylene glycol alkyl ether, etc. The heterocyclic compound may be 3-methyl-2-oxazolidinone, etc. The nitrile compound may be acetonitrile, glutaronitrile, methoxyacetonitrile, propionitrile, and benzonitrile, etc.

The polyhydric alcohol filled in the electrolyte layer may be added to the conductive polymer solution or may be filled in the electrolyte layer at the same time as the conductive polymer. Since the polyhydric alcohol has a high boiling point, the polyhydric alcohol remains in the electrolyte layer even after the electrolyte layer is impregnated with the conductive polymer solution and is dried. Preferably, the polyhydric alcohol is contained in an amount of 8 wt % to 50 wt % relative to the total amount of the conductive polymer solution. When the polyhydric alcohol is contained in this range, the polyhydric alcohol contained in the electrolyte layer more effectively suppresses the deterioration of the conductive polymer, and the change in ESR is further suppressed.

Particular preferably, the polyhydric alcohol is contained in an amount of 8 wt % to 30 wt % relative to the total amount of the conductive polymer solution. In this range, the change in ESR due to the repeated thermal shock can be suppressed than when the electrolytic solution contains the anion component with the acid dissociation constant pKa=4.51 or less. If the contained amount of the polyhydric alcohol increases over 30 wt % relative to the total amount of the conductive polymer solution, the suppression effect of the change in ESR by the contained the polyhydric alcohol decreases to the same level as when the electrolytic solution contains the acid dissociation constant pKa=4.51 or less.

The pH of the conductive polymer solution may be adjusted by ammonia water. Furthermore example, organic binders, surfactants, dispersants, defoamers, coupling agents, antioxidants, UV absorbers, and the like may be added.

### (Separator)

The separator includes cellulose such as kraft, Manila hemp, esparto, hemp, rayon, and mixed papers thereof, polyester resin such as polyethylene terephthalate, polybutylene terephthalate, polyethylene naphthalate, and derivatives thereof, polytetrafluoroethylene resin, polyvinylidene fluoride resin, vinylon resin, polyamide resin such as aliphatic polyamide, semi-aromatic polyamide, and aromatic total polyamide, polyimide resin, polyethylene resin, polypropylene resin, trimethylpentene resin, polyphenylene sulfide resin, resin, acrylic polyvinyl alcohol resin and the like, and these resins may be used in single or in combination.

Hereinafter, the solid electrolytic capacitors of the examples will be described in more detail. Note that the present disclosure is not limited to the following examples.

### Examples 1 and 2

Solid electrolytic capacitors of the examples 1 and 2, and the comparative examples 1 and 2 were produced. Firstly, the anode body and the cathode body were produced using aluminum foil. The surface of the anode body was enlarged by etching.

Next, the anode body was immersed in aqueous solution of adipic acid and applied with chemical conversion voltage to form the dielectric film. The surface of the cathode body was enlarged by etching. The anode body and the cathode body were each connected to lead wire and were wound to face each other via a cellulose separator. The wound body was immersed in aqueous solution of ammonium dihydrogen phosphate for 30 minutes to perform restorative chemical conversion. Then, the wound body was dried at 100 degrees.

The wound body was immersed in the conductive polymer solution to attach the conductive polymer on the dielectric film of the anode body, the cathode body, and the separator. For the conductive polymer solution, particles of poly(3,4-dioxythiophene) doped with polystyrene sulfonic acid was dispersed as the conductive polymer in water, and ethylene glycol was added. After the wound body was immersed in the conductive polymer solution for the first time, the wound body was dried for 30 minutes at 145 degrees. Furthermore, after the wound body was immersed in the conductive polymer solution for the second time, the wound body was dried for 30 minutes at 150 degrees.

Here, in the comparative example 1, the conductive polymer solution in which the comparative example with the median diameter of 450 nm was dispersed in the dispersion medium was used. In the comparative example 2, the conductive polymer solution in which the comparative example with the median diameter of 168 nm was dispersed in the dispersion medium was used. In the example 1, the conductive polymer solution in which the comparative example with the median diameter of 47 nm was dispersed in the dispersion medium was used. In the example 2, the conductive polymer solution in which the comparative example with the median diameter of 10 nm was dispersed in the dispersion medium was used. The dispersion medium was water, and pH of conductive polymer solution with the conductive polymer concentration of 2 wt % was adjusted to 4 using ammonia water and was dispersed using an ultrasonic homogenizer to prepare the conductive polymer solution.

The particle size of the conductive polymer was measured using a particle size distribution measurement apparatus. Firstly, the conductive polymer solution with adjusted pH was diluted 100-fold with water, and was sonicated. The particle size was measured using this diluted aqueous solution with a particle size distribution measurement apparatus (UPA-UT151 from Nikkiso)

Furthermore, the wound body in which the electrolyte layer of the conductive polymer was had been formed was impregnated with the electrolytic solution. The solvent of the electrolytic solution was ethylene glycol. Azelaic acid and ammonia were mixed to the electrolytic solution at 16 mmol per 100 g of the electrolytic solution. The anion component of the electrolytic solution was azelaic acid.

After the electrolyte layer was formed by the conductive polymer and the electrolytic solution, the capacitor element was housed in an outer casing with a bottom. A sealing rubber was mounted to an opened end of the outer casing, and the outer casing was sealed by a crimping process. Each of the solid electrolytic capacitors was aged by voltage application. Each solid electrolytic capacitor had a diameter of 6.3 mm, a height of 5.8 mm, the rated withstand voltage of 35 WV, and the rated capacity of 47 μF.

Furthermore, solid electrolytic capacitors of the comparative example 3 and the reference examples 1 to 3 were produced. In the solid electrolytic capacitor of the comparative example 3, suberic acid was used as the anion component of the electrolytic solution. For the other points, the solid electrolytic capacitor of the comparative example 3 was produced with the same configuration, the same manufacturing method, and the same manufacturing condition as the example 1. That is, in the solid electrolytic capacitor of the comparative example 3, the comparative example with the median diameter of 450 nm was used.

The solid electrolytic capacitor of the reference example 1 was produced with the same configuration, the same manufacturing method, and the same manufacturing condition as the example 1 including that the median diameter of the conductive polymer was 450 nm and except that pimelic acid was used as the anion component of the electrolytic solution. The solid electrolytic capacitor of the reference example 2 was produced with the same configuration, the same manufacturing method, and the same manufacturing condition as the example 1 including that the median diameter of the conductive polymer was 450 nm and except that glutaric acid was used as the anion component of the electrolytic solution. The solid electrolytic capacitor of the reference example produced 3 was with the same configuration, the same manufacturing method, and the same manufacturing condition as the example 1 including that the median diameter of the conductive polymer was 450 nm and except that succinic acid was used as the anion component of the electrolytic solution.

Note that azelaic acid had the acid dissociation constant pKa=4.55, suberic acid had the acid dissociation constant pKa=4.526, pimelic acid had the acid dissociation constant pKa=4.51, glutaric acid had the acid dissociation constant pKa=4.31, and succinic acid had the acid dissociation constant pKa=4.20.

### (Thermal Shock Test)

The change in ESR after the thermal shock test was measured by repeatedly applying the thermal shock to the solid electrolytic capacitors of the examples 1 and 2, the comparative examples 1 to 3, and the reference example examples 1 to 3. The thermal shock test is as follow. Firstly, reflow heat at the time of implementation was applied to the solid electrolytic capacitor. The ESR of the solid electrolytic capacitor after being exposed to reflow heat was measured. The ESR was measured used a LCR meter (from Agilent Technologies, E4980A) with setting of the alternating current level set of 1.0 Vrms, the measurement frequency of 100 kHz, and DC bias. The ESR after being exposed to reflow heat is called the initial ESR.

After the measurement of the initial ESR, the temperature environment around the solid electrolytic capacitor was repeatedly changed between high temperature and low temperature. The high-temperature environment was 155 degrees, and the low-temperature environment was-55 degrees. A cycle of exposing the solid electrolytic capacitor under the high-temperature environment for 30 minutes and then exposing under the low-temperature environment for 30 minutes was repeated for 150 hours. After the thermal shock test for 150 hours, the ESR was measured again, and the percentage of the ESR after the thermal shock test relative to the initial ESR was calculated as the change in ESR (ΔESR).

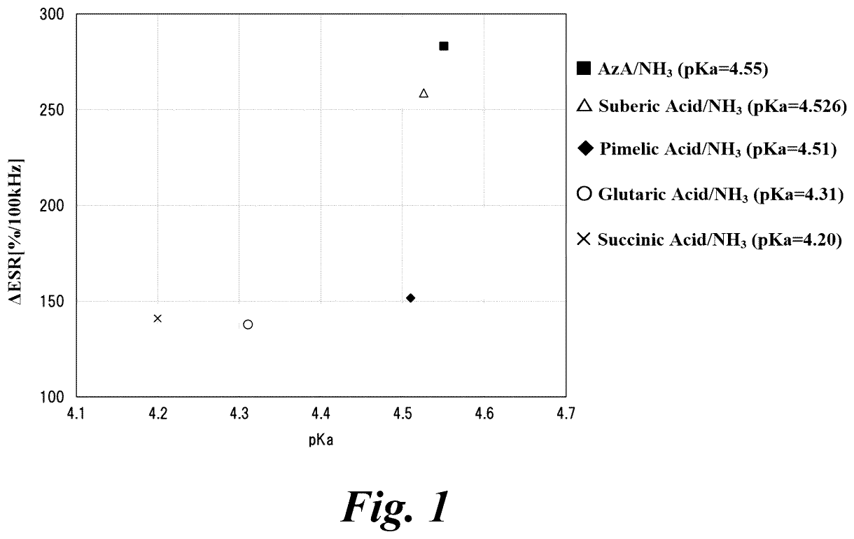

The change in ESR of the solid electrolytic capacitors of the comparative examples 1 and 3 and the reference example examples 1 to 3 are shown in the below table 1. Furthermore, FIG. 1 is a graph created based on the below table 1, in which the horizontal axis indicates the acid dissociation constant pKa and the vertical axis indicated the change in ESR. In the figure, AzA is azelaic acid.

TABLE 1

| | Anionic Component | | | |
|---|---|---|---|---|
| | | Acid | Conductive | |
| | Anionic | Dissociation | Polymer D50 | AESR |
| | Species | Constant pKa | (nm) | (%) |
| Comparative | Azelaic Acid | 4.55 | 450 | 283.2 |
| Example 1 | | | | |
| Comparative | Suberic Acid | 4.526 | 450 | 258.6 |
| Example 3 | | | | |
| Reference | Pimelic Acid | 4.51 | 450 | 151.7 |
| Example 1 | | | | |
| Reference | Glutaric Acid | 4.31 | 450 | 137.9 |
| Example 2 | | | | |
| Reference | Succinic Acid | 4.20 | 450 | 133.3 |
| Example 3 | | | | |

As shown in the table 1 and FIG. 1, the change in ESR after the thermal shock test was excellent in the reference examples 1 to 3 containing the anion component with the acid dissociation constant pKa=4.51 or less in the electrolytic solution. In contrast, the change in ESR after the thermal shock test in the comparative examples 1 and 3 containing the anion component with the acid the dissociation constant pKa=4.52 or more in t electrolytic solution was at least 1.7 times that of the reference examples 1 and 3, meaning that the ESR became worse. Accordingly, it was observed that the ESR of the solid electrolytic capacitor containing the anion component with the acid dissociation constant pKa=4.52 or more in the electrolytic solution became worse when repeatedly undergone the thermal shock.

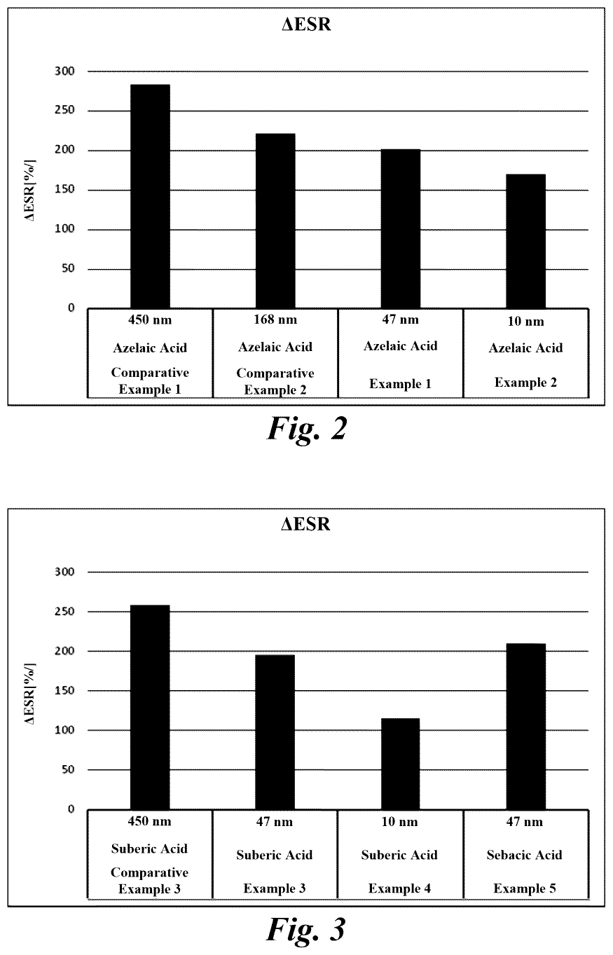

Meanwhile, the result of the change in ESR of the solid electrolytic capacitors of the comparative examples 1 and 2, the examples 1 and 2 are shown in the below table 2. Furthermore, FIG. 2 is a graph indicating the change in ESR of the comparative examples 1 and 2, and the examples 1 and 2 based on the below table 2.

TABLE 2

| | Anionic Component | | | |
|---|---|---|---|---|
| | | Acid | Conductive | |
| | Anionic | Dissociation | Polymer D50 | AESR |
| | Species | Constant pKa | (nm) | (%) |
| Comparative | Azelaic Acid | 4.55 | 450 | 283.2 |
| Example 1 | | | | |
| Comparative | | | 168 | 221.3 |
| Example 2 | | | | |
| Example 1 | | | 47 | 201.9 |
| Example 2 | | | 10 | 169.9 |

As shown in the table 2 and FIG. 2, it was observed that, when the anion component with the acid dissociation constant pKa=4.52 or more was contained in the electrolytic solution and the conductive polymer with the median diameter of 50 nm or less was used together, the change in ESR when the solid electrolytic capacitor had repeatedly undergone the thermal shock became small.

### Examples 3 to 5

Furthermore, the solid electrolytic capacitors of the examples 3 to 5 were produced. In the solid electrolytic capacitor of the example 3, suberic acid was used as the anionic component of the electrolytic solution. For the other points, the solid electrolytic capacitor of the example 3 was produced with the same configuration, the same manufacturing method, and the same manufacturing condition as the example 1. That is, in the solid electrolytic capacitor of the comparative example 3, the conductive polymer with the median diameter of 47 nm was used.

The solid electrolytic capacitor of the example 4 was produced using suberic acid was used as the anionic component of the electrolytic solution, and the conductive polymer solution in which the conductive polymer with the median diameter of 10 nm was dispersed in the dispersion medium. For the other points, the solid electrolytic capacitor of the example 4 was produced with the same configuration, the same manufacturing method, and the same manufacturing condition as the example 1.

In the solid electrolytic capacitor of the example 5, sebacic acid was used as the anionic component of the electrolytic solution. For the other points, the solid electrolytic capacitor of the example 5 was produced with the same configuration, the same manufacturing method, and the same manufacturing condition as the example 1. That is, in the solid electrolytic capacitor of the example 5, the conductive polymer with the median diameter of 47 nm was used. Note that sebacic acid had the acid dissociation constant pKa=4.59.

### (Thermal Shock Test 2)

The change in ESR after the thermal shock test was measured by repeatedly applying the thermal shock to the solid electrolytic capacitors of the examples 3 to 5. The content of the thermal shock test and the measurement condition of the ESR were the same as those for the comparative examples 1 to 3 and the examples 1 to 3.

The change in ESR of the solid electrolytic capacitors of the comparative examples 3 and the example examples 3 to 5 are shown in the below table 3. Furthermore,

FIG. 3 is a graph indicating the change in ESR of the comparative examples 3 and the examples 3 to 5 created based on the below table 3.

TABLE 3

| | Anionic Component | | | |
|---|---|---|---|---|
| | | Acid | Conductive | |
| | Anionic | Dissociation | Polymer D50 | AESR |
| | Species | Constant pKa | (nm) | (%) |
| Comparative | Suberic Acid | 4.526 | 450 | 258.6 |
| Example 3 | | | | |
| Example 3 | | | 47 | 195.7 |
| Example 4 | | | 10 | 114.8 |
| Example 5 | Sebacic Acid | 4.59 | 47 | 209.8 |

As shown in the table 3 and FIG. 3, it was observed that, when suberic acid or sebacic acid were contained in the electrolytic solution and the conductive polymer with the median diameter of 50 nm or less was used together, the change in ESR when the solid electrolytic capacitor had repeatedly undergone the thermal shock became small. Suberic acid and sebacic acid were the anionic component with the acid dissociation constant pKa=4.52 or more, like azelaic acid. Therefore, it was observed that, when the anionic component with the acid dissociation constant pKa=4.52 or more was contained in the electrolytic solution and the conductive polymer with the median diameter of 50 nm or less was used together, the change in ESR when the solid electrolytic capacitor had repeatedly undergone the thermal shock became small regardless of the types of the anionic component.

### Examples 6 to 12

Furthermore, the solid electrolytic capacitors of the examples 6 to 12 were produced. The examples 6 to 12 were different from the example 1 in that the polyhydric alcohol was added to the conductive polymer solution and the electrolyte layer contained the polyhydric alcohol. Other configuration, composition, manufacturing method, and manufacturing condition of the examples 6 to 12 were the same as the example 1 including that the anionic component was azelaic acid with the acid dissociation constant pKa=4.52 or more and the median diameter of the conductive polymer was 47 nm.

1-hexanol was added to the electrolytic conductive polymer solution of the example 6. Ethylene glycol was added to the conductive polymer solution of the example 7. Diethylene glycol was added to the conductive polymer solution of the example 8. Glycerin was added to the conductive polymer solution of the example 9. Polyethylene glycol with the average molecular weight of 300 was added to the conductive polymer solution of the example 10. Sorbitol was added to the conductive polymer solution of the example 11. Xylitol was added to the conductive polymer solution of the example 12. The amount of the polyhydric alcohol added to the conductive polymer solution of the examples 6 to 12 was 8 wt % relative to the conductive polymer solution which was adjusted to pH 4.

The change in ESR after the thermal shock test was measured by repeatedly applying the thermal shock to the solid electrolytic capacitors of the examples 6 to 12. The content of the thermal shock test and the measurement condition of the ESR were the same as those for the comparative example 1 and the examples 1 and 2.

The change in ESR of the solid electrolytic capacitors of the examples 6 to 12 are shown in the below table 4. Furthermore, FIG. 4 is a graph indicating the change in ESR of the examples 6 to 12 created based on the below table 4.

TABLE 4

| | Anionic Component | | Conductive | | |
|---|---|---|---|---|---|
| | Anionic | Acid Dissociation | Polymer D50 | Polyhydric | AESR |
| | Species | Constant pKa | (nm) | Alcohol | (%) |
| Example 1 | Azelaic Acid | 4.55 | 47 | — | 201.9 |
| Example 6 | | | | 1-hexanol | 131.4 |
| Example 7 | | | | Ethylene Glycol | 123.7 |
| Example 8 | | | | Diethylene Glycol | 115.2 |
| Example 9 | | | | Glycerin | 114.3 |
| Example 10 | | | | Polyethylene | 105.4 |
| | | | | Glycol | |
| Example 11 | | | | Sorbitol | 101.4 |
| Example 12 | | | | Xylitol | 100.7 |
| Reference | Succinic | 4.2 | 450 | — | 133.3 |
| Example 3 | Acid | | | | |

As shown in the table 4 and the example 4, in the examples 6 to 12, the change in ESR was suppressed more than the example 1. Also, in the examples 6 to 12, the change in ESR was smaller than the reference examples 1 to 3 in which the change in ESR was small. Therefore, it was observed that, when the anionic component with the acid dissociation constant pKa=4.52 or more, and the median diameter of the conductive polymer was 50 nm or less and the electrolyte layer contained the polyhydric alcohol, the change in ESR can be made small compared with when the anionic component with the acid dissociation constant pKa=4.51 or less was contained in the electrolytic solution.

Also, the change in ESR could not be seen in the examples 10 to 12. That is, it was observed that, when polyethylene glycol, xylitol, or sorbitol was contained in the electrolyte layer, the change in ESR could be almost suppressed even if the solid electrolytic capacitor had repeatedly undergone the thermal shock.

### Examples 13 to 14

Furthermore, the solid electrolytic capacitors of the examples 13 and 14 were produced. In the examples 13 and 14, ethylene glycol was added to the conductive polymer solution as the polyhydric alcohol, like the example 7. In the example 7, the amount of ethylene glycol added to the conductive polymer solution was 8 wt % relative to the conductive polymer solution which was adjusted to pH 4, whereas in the example 13, the amount of ethylene glycol added to the conductive polymer solution was 30 wt % relative to the conductive polymer solution, and in the example 14, the amount of ethylene glycol added to the conductive polymer solution was 50 wt % relative to the conductive polymer solution. Other configuration, composition, manufacturing method, and manufacturing condition of the examples 13 and 14 were the same as the example 7.

The change in ESR after the thermal shock test was measured by repeatedly applying the thermal shock to the solid electrolytic capacitors of the examples 13 and of the thermal shock test and the 14. The content measurement condition of the ESR were the same as those for the comparative example 1 and the examples 1 and 2.

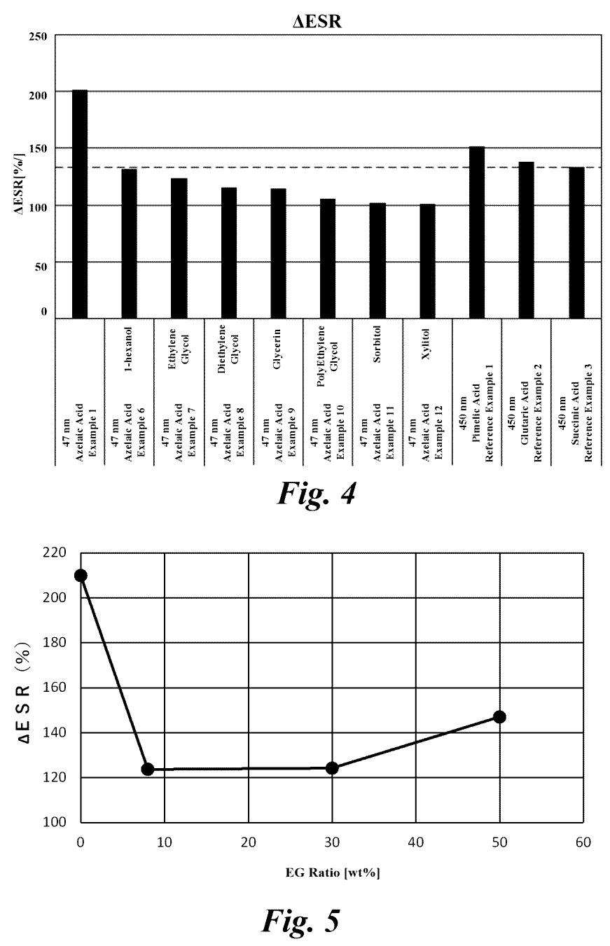

The result of the change in ESR of the solid electrolytic capacitors of the examples 1, 7, 13, and 14 are shown in the below table 5. Furthermore, FIG. 5 is a graph indicating the relationship between the addition ratio of the polyhydric alcohol and the change in ESR created based on the below table 5.

TABLE 5

| | | | | Addition | |
|---|---|---|---|---|---|
| | Anionic Component | | Conductive | Amount of | |
| | Anionic | Acid Dissociation | Polymer D50 | Ethylene | AESR |
| | Species | Constant pKa | (nm) | Glycol (wt %) | (%) |
| Example 1 | Azelaic Acid | 4.55 | 47 | 0 | 209.9 |
| Example 7 | | | | 8 | 123.7 |
| Example 13 | | | | 30 | 124.2 |
| Example 14 | | | | 50 | 147 |

As shown in the table 5 and FIG. 5, it was observed that, when the polyhydric alcohol was added in a range of 8 wt % to 50 wt % relative to the conductive polymer solution, the change in ESR when the solid electrolytic capacitor had repeatedly undergone the thermal shock became small. In particular, it was observed that, when the polyhydric alcohol was added in a range of 8 wt % to 50 wt % relative to the conductive polymer solution, the change in ESR can be made small compared with when the anionic component with the acid dissociation constant pKa=4.51 or less was contained in the electrolytic solution.

### Examples 15 to 22

The solid electrolytic capacitors of the examples 15 to 22 were produced. In the examples 15 to 22, the anionic component with the acid dissociation constant pKa=4.51 or less was added to the electrolyte layer, in addition to azelaic acid with the acid dissociation constant pKa=4.52 or more. Other configuration, composition, manufacturing method, and manufacturing condition of the examples 15 to 22 were the same as the example 2.

The anionic component and ammonia were mixed to the electrolytic solution of the examples 15 to 17 at 16 mmol per 100 g of the electrolytic solution. The anionic component was the mixture of azelaic acid and glutaric acid with the acid dissociation constant pKa=4.31. In the example 15, azelaic acid and glutaric acid was mixed in a molar ratio of 1:1. In the example 16, azelaic acid and glutaric acid was mixed in a molar ratio of 2:1, that is, azelaic acid was twice the amount of glutaric acid. In the example 17 azelaic acid and glutaric acid was mixed in a molar ratio of 3:1, that is, azelaic acid was three times the amount of glutaric acid.

The anionic component and ammonia were mixed to the electrolytic solution of the examples 18 to 20 at 16 mmol per 100 g of the electrolytic solution. The anionic component was the mixture of azelaic acid and succinic acid with the acid dissociation constant pKa=4.2. In the example 18, azelaic acid and succinic acid was mixed in a molar ratio of 1:1. In the example 19, azelaic acid and succinic acid was mixed in a molar ratio of 2:1, that is, azelaic acid was twice the amount of succinic acid. In the example 20, azelaic acid and succinic acid was mixed in a molar ratio of 3:1, that is, azelaic acid was three times the amount of succinic acid.

Note that the amount of azelaic acid contained in the electrolytic solution in the examples 21 and 22 was different from the example 2. In the example 2, azelaic acid and ammonia was mixed to the electrolytic solution at 16 mmol per 100 g of the electrolytic solution, whereas in the example 21, azelaic acid and ammonia were mixed to the electrolytic solution at 12 mmol per 100 g of the electrolytic solution, and in the example 22, azelaic acid and ammonia were mixed to the electrolytic solution at 10.6 mmol per 100 g of the electrolytic solution.

The change in ESR after the thermal shock test was measured by repeatedly applying the thermal shock to the solid electrolytic capacitors of the examples 15 and 22. The content of the thermal shock test and the measurement condition of the ESR were the same as those for the comparative example 1 and the examples 1 and 2.

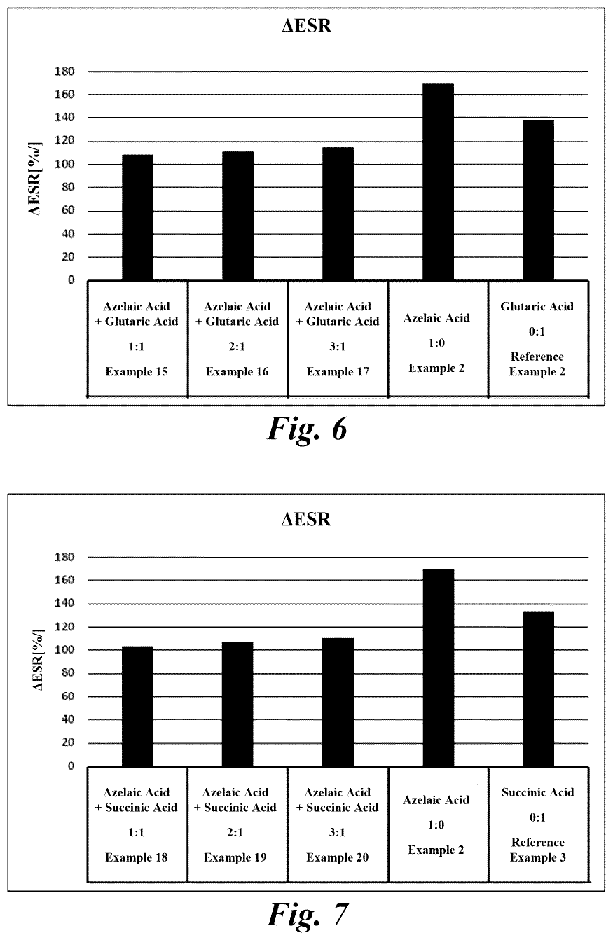

The result of the change in ESR of the solid electrolytic capacitors of the examples 2 and 15 to 22, and the reference examples 2 and 3 are shown in the below table 6. Furthermore, FIG. 6 is a graph indicating the change in ESR of the examples 2 and 15 to 17, and FIG. 7 is a graph indicating the change in ESR of the examples 2 and 18 to 20, both created based on the below table 6.

TABLE 6

| | Anionic Component | | Anionic Component | | | Addition | | |
|---|---|---|---|---|---|---|---|---|
| | A1 with pKa = 4.52 | | A2 with pKa = 4.51 | | | Amount | | |
| | or more | | or less | | Anionic | of Anionic | | |
| | | Acid | | Acid | Compo- | Compo- | | |
| | | Dissociation | | Dissociation | nent | nent | Conductive | |
| | Anionic | Constant | Anionic | Constant | Ratio | (mmol) | Polymer | ΔESR |
| | Species | pKa | Species | pKa | A1:A2 | A1:A2 | D50 (nm) | (%) |
| Example 2 | Azelaic | 4.55 | — | — | 1:0 | 16.0:0 | 10 | 169.6 |
| Example 15 | Acid | | Glutaric | 4.31 | 1:1 | 8:8 | | 108.7 |
| Example 16 | | | Acid | | 2:1 | 10.6:5.3 | | 111.3 |
| Example 17 | | | | | 3:1 | 12:4 | | 114.5 |
| Reference | — | — | | | 0:1 | 16.0 | 450 | 137.9 |
| Example 2 | | | | | | | | |
| Example 18 | Azelaic | 4.55 | Succinic | 4.2 | 1:1 | 8:8 | 10 | 103.8 |
| Example 19 | Acid | | Acid | | 2:1 | 10.6:5.3 | | 106.8 |
| Example 20 | | | | | 3:1 | 12:4 | | 110.7 |
| Reference | — | — | | | 0:1 | 16.0 | 450 | 133.3 |
| Example 3 | | | | | | | | |
| Example 21 | Azelaic | 4.55 | — | — | 1:0 | 12:0 | 10 | 152.3 |
| Example 22 | Acid | | — | — | 1:0 | 10.6:0 | | 131.3 |

Firstly, as shown in the table 6, the change in ESR was suppressed in the example 21 compared to the example 2, and the change in ESR was further suppressed in the example 22 compared to the example 21. As a result, it was observed that, bu reducing the amount of the anionic component with pKa=4.52 or more, the change in ESR of the solid electrolytic capacitor is suppressed even when the solid electrolytic capacitor had repeatedly undergone the thermal shock.

Furthermore, as shown in the table 6, and FIGS. 6 and 7, it was observed that, when the anionic component with the acid dissociation constant pKa=4.51 or less was added to the electrolyte layer in addition to azelaic acid with the acid dissociation constant pKa=4.52 or more, the change in ESR can be almost suppressed even when the electrolytic capacitor had repeatedly undergone the thermal shock.

In particular, as can be observed from the comparison with the reference examples 2 and 3, the change in ESR is suppressed more than the capacitor in which the aliphatic dicarboxylic acid with the acid dissociation constant pKa=4.51 or less was contained in the electrolytic solution, despite that a large amount of the aliphatic dicarboxylic acid with the acid dissociation constant pKa=4.52 or more was contained in the electrolytic solution which makes the change in ESR when repeatedly undergone the thermal shock larger.

Here when comparing the examples 21, 17, and 20, it can be observed that, although the amount of azelaic acid with pKa=4.52 or more was the same, in the examples 17 and 20, the change in ESR was further suppressed than the example 21, and the suppression effect of the change in ESR was higher than the reference examples 2 and 3. Furthermore, when comparing the examples 22, 16, and 19, it can be observed that, although the amount of azelaic acid with pKa=4.52 or more was the same, in the examples 16 and 19, the change in ESR was further suppressed than the example 22, and the suppression effect of the change in ESR was higher than the reference examples 2 and 3.

That is, it was observed that, the interaction between the aliphatic dicarboxylic acid with the acid dissociation constant pKa=4.52 or more, the aliphatic dicarboxylic acid with the acid dissociation constant pKa=4.51 or less, and the conductive polymer with D50 in the particle size distribution of 50 nm or less significantly contributed to suppressing the change in ESR more than the simple decrease in the amount of the aliphatic dicarboxylic acid with the acid dissociation constant pKa=4.52 or more which makes the change in ESR when repeatedly undergone the thermal shock larger.

It was observed that the deterioration due to the repeated thermal shock only occurred in the hybrid capacitor with the conductive polymer and the electrolytic solution combined, and not in the electrolytic capacitor using only the electrolytic solution and the solid electrolytic capacitor using only the conductive polymer.

1. A solid electrolytic capacitor comprising:
an anode body containing valve metal and has dielectric film formed on a surface thereof;
a cathode body facing the anode body; and
an electrolyte layer intervening between the anode body and the cathode body and containing electrolytic solution and a conductive polymer,
wherein:
the electrolytic solution contains aliphatic dicarboxylic acid with an acid dissociation constant pKa=4.52 or more, and
D50 in a particle size distribution of the conductive polymer is 50 nm or less.

2. The solid electrolytic capacitor according to claim 1, wherein the electrolyte layer contains polyhydric alcohol.

3. The solid electrolytic capacitor according to claim 1, wherein the electrolyte layer is formed using conductive polymer solution containing the conductive polymer and polyhydric alcohol.

4. The solid electrolytic capacitor according to claim 3, wherein the polyhydric alcohol is contained in an amount of 8 wt % to 50 wt % relative to a total amount of the conductive polymer solution.

5. The solid electrolytic capacitor according to claim 3, wherein the polyhydric alcohol is contained in an amount of 8 wt % to 30 wt % relative to a total amount of the conductive polymer solution.

6. The solid electrolytic capacitor according to claim 3, wherein the polyhydric alcohol is one type or a mixture of two or more types selected from a group of polyethylene glycol, xylitol, and sorbitol.

7. The solid electrolytic capacitor according to claim 1, wherein the aliphatic dicarboxylic acid is one type or a mixture of two or more types selected from a group of azelaic acid, suberic acid, and sebacic acid.

8. The solid electrolytic capacitor according to claim 1, wherein the electrolytic solution further contains the aliphatic carboxylic acid with the acid dissociation constant pKa=4.51 or less.

9. A manufacturing method of a solid electrolytic capacitor, comprising:
a conductive polymer attachment process of attaching and drying conductive polymer solution to an anode body which has dielectric film formed on a surface thereof or a capacitor element in which said anode body and a cathode body are facing each other; and
an electrolytic solution impregnation process of impregnating the capacitor element with electrolytic solution after the conductive polymer attachment process,
wherein:
the electrolytic solution contains aliphatic dicarboxylic acid with an acid dissociation constant pKa=4.52 or more, and
D50 in a particle size distribution of the conductive polymer is 50 nm or less.

10. The manufacturing method according to claim 9, wherein an electrolyte layer is formed using conductive polymer solution containing the conductive polymer and polyhydric alcohol.

11. The manufacturing method according to claim 10, wherein the polyhydric alcohol is contained in an amount of 8 wt % to 50 wt % relative to a total amount of the conductive polymer solution.

12. The manufacturing method according to claim 10, wherein the polyhydric alcohol is one type or a mixture of two or more types selected from a group of polyethylene glycol, xylitol, and sorbitol.

13. The manufacturing method according to claim 9, wherein the aliphatic dicarboxylic acid is one type or a mixture of two or more types selected from a group of azelaic acid, suberic acid, and sebacic acid.

14. The solid electrolytic capacitor according to claim 9, wherein the electrolytic solution further contains the aliphatic carboxylic acid with the acid dissociation constant pKa=4.51 or less.
